(19) United States
(12) Patent Application Publication
(10) Pub. No.: US 2002/0081986 A1
(43) Pub. Date: Jun. 27, 2002

(54) Method and system for adjusting amplification

(76) Inventor: Naoki Yokoyama, Tokyo (JP)

Correspondence Address: KNOBLE & YOSHIDA, LLC, Eight Penn Center, Suite 1350, 1628 John F. Kennedy Blvd., Philadelphia, PA, 19103, US

(21) Appl. No.: 10/017,064

(22) Filed: Dec. 14, 2001

(30) Foreign Application Priority Data
Dec. 22, 2000 (JP) 2000-390359

(51) Int. Cl. H04Q 7/20

(52) U.S. Cl. 455/234.1; 234/1; 455/69; 455/522

(57) ABSTRACT

Since a pair of units associated with an antenna unit and a base processing unit is separately placed at a various distance with each other, communication signals also attenuate at a various rate. The amplification gain is adjusted at one unit based upon a receiving signal and a predetermined reception sensitivity level until a desirable amplification is achieved. The desirable amplification value is then transmitted to the other unit to be utilized for reciprocal communication at a desired level between the two units.

### FIELD OF THE INVENTION

The current invention is generally related to a wireless communication system and and is particularly related to a variable amplifier for controlling a gain based upon the length of cable that connects units in the wireless communication system.

### DESCRIPTION OF RELATED PRIOR ART

In a wireless communication system, antennas are placed at locations where the wireless communication signal is not affected for transmission. A unit that processes wireless communication signals via the antenna is isolated from other parts or units and is connected to the rest of the system via communication cable. Due to the above separation, the antenna unit has become compact and light weight. The compact antenna unit is thus easily placed at high locations such as the top of buildings or towers. For example, wireless communication such as fixed wireless access (FWA) includes the above described separated unit in base stations and subscriber stations.

Referring to FIG. 7, an exemplary wireless access systems include a base station 1 and subscriber stations 2. The base station 1 is connected to a public network 4 via cable 3. Although it is not illustrated, each of the subscriber stations 2 is connected to a subscriber network such as LAN. Based upon the wireless communication between the base station 1 and the subscriber stations 2, the communication is implemented between the subscriber networks and or between the subscriber network and the public network. The base station 1 and the subscriber stations 2 include an outdoor unit (ODU) 7 for processing wireless communication signals for antennas 6, an indoor unit (IDU) 8 for processing communication signals with communication networks such as public networks and subscriber networks in the backbone as well as a cable 9 that connects the ODU 7 to the IDU 8. The ODU 7 is placed at high locations such as the roof top of a building 10 where there is no interfering object and optimizes the wireless communication via the antenna 6. On the other hand, the IDU 8 is placed inside the building 10 easy maintenance without the influence by the external factors such as temperature change.

Now referring to FIG. 8, a diagram illustrates an exemplary separation unit for the base station 1 and the subscriber station 2. The ODU 7 includes a wireless communication unit or RF unit 10 for processing wireless communication signals to and from the antenna 6 while the IDU 8 includes a communication unit 11 for communicating with networks in the backbone and a control unit 12 for controlling the entire wireless communication system. That is, the ODU 7 located outdoors is made compact and light weight by removing non-wireless functions. The ODU 7 is easily handled at high locations. The wireless communication units 8 and 9 are connected via the communication cable 9, and the amplification gain is adjusted depending upon the length of the communication cable 9. For example, as the ODU 7 is placed at a high location or a distant location, the length of the cable 9 varies and ranges from 1 meter to 300 meters. Because of the variable cable length, the transmission loss also varies and a desirable initial reception sensitivity is not obtained between the units. As described above, the amplification gain of a transmission amplifier must be adjusted based upon the cable length. Furthermore, since the original reception sensitivity is not uniform among the IDU'S 7 due to manufacturing error, the transmission amplifier gain must be also adjusted in addition to the cable length.

In response to these variations, during the past wireless communication system installation, a worker measured the sensitivity between the units and adjusted the transmission amplification gain. The above described manual operation had been quite difficult. Since the ODU 7 is located outdoors and the IDU 8 is located indoors, the IDU 7 is managed under temperature control while the ODU 7 is affected by the temperature during seasons. The reception sensitivity for communication via communication cable 9 also varies depending upon temperature. In order to maintain the original reception sensitivity, the above described complex gain adjustments must be manually repeated after installation. For the above reasons, it is desired that the amplification gain is automatically adjusted to eliminate the cumbersome manual adjustments as well as to provide good communication between the units via the communication cable.

Japanese Patent Publication Hei 6-291685 discloses a wireless communication system for automatically adjusting amplification between two units. The units must transmit the original output level information in the data signal to a receiving unit in the above described system. Because of the above and other requirements, it is desired to simplify the system

### SUMMARY OF THE INVENTION

In order to solve the above and other problems, according to a first aspect of the current invention, a method of adjusting amplification gain for a communication signal, includes the steps of: storing a predetermined standard reception sensitivity value; amplifying the communication signal at an amplification level at a first unit; transmitting the amplified communication signal from the first unit to a second unit; receiving the communication signal at the second unit; comparing the received communication signal to the predetermined standard reception sensitivity value to generate a comparison signal; adjusting the amplification level at the first unit based upon the comparison signal until a desirable amplification is reached; transmitting the amplification level from the first unit to the second unit upon achieving the desirable amplification; and storing the amplification level at the second unit for amplification gain at the second unit.

According to a second aspect of the current invention, a system for adjusting amplification gain for a communication signal, includes: a first unit including a first amplifier for amplifying the communication signal at an amplification level, a first transmitter connected to the amplifier for transmitting the amplified communication signal and a first memory for storing an amplification level; and a second unit connected to said first unit including a receiver for receiving the communication signal, a second memory for storing a predetermined standard reception sensitivity value and a comparator for comparing the received communication signal to the predetermined standard reception sensitivity value to generate a comparison signal, wherein said first unit adjusts the amplification level of the first amplifier to a desirable amplification level based upon the comparison signal until a desirable amplification is reached at said second unit, said first unit storing the amplification level in the first memory, said first unit transmitting the desirable amplification level to said second unit upon achieving the desirable amplification, the second unit storing the desirable amplification level.

According to a third aspect of the current invention, a system for adjusting amplification gain for a communication signal, includes: a first unit including a first amplifier for amplifying the communication signal at an amplification level, a first transmitter connected to the amplifier for transmitting the amplified communication signal, a first memory for storing a predetermined standard reception sensitivity value and a comparator for comparing two signals; and a second unit connected to said first unit including a receiver for receiving the communication signal, said second unit transmitting the received communication signal back to said first unit, wherein the comparator compares the received communication signal from said second unit to the predetermined standard reception sensitivity value to generate a comparison signal, said first unit adjusting the amplification level of the first amplifier to a desirable amplification level based upon the comparison signal until a desirable amplification is reached at said second unit, said first unit transmitting the desirable amplification level to said second unit upon achieving the desirable amplification, said second unit storing the desirable amplification level.

According to a fourth aspect of the current invention, a system for adjusting amplification gain for a communication signal, includes: a first unit including a first amplifier for amplifying the communication signal at an amplification level, a first transmitter connected to the amplifier for transmitting the amplified communication signal, a first memory for storing an amplification value and a comparator for comparing two signals; and a second unit connected to said first unit including a receiver for receiving the communication signal and a second memory for storing a predetermined standard reception sensitivity value, said second unit sending the predetermined standard reception sensitivity value to the first memory in said first unit, said second unit transmitting the received communication signal back to said first unit, wherein the comparator compares the received communication signal from said second unit to the predetermined standard reception sensitivity value to generate a comparison signal, said first unit adjusting the amplification level of the first amplifier to a desirable amplification level based upon the comparison signal until a desirable amplification is reached at said second unit, said first unit transmitting the desirable amplification level to said second unit upon achieving the desirable amplification, said second unit storing the desirable amplification level.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram illustrating a first preferred embodiment of the base station in the wireless communication system according to the current invention.

FIG. 2 is a timing chart illustrating a process of setting a transmission amplifier gain value as used by the first preferred embodiment of the base station according to the current invention.

FIG. 3 is a diagram illustrating a second preferred embodiment of the base station in the wireless communication system according to the current invention.

FIG. 4 is a timing chart illustrating a process of setting a transmission amplifier gain value as used by the second preferred embodiment of the base station according to the current invention.

FIG. 5 is a diagram illustrating a third preferred embodiment of the base station in the wireless communication system according to the current invention.

FIG. 6 is a timing chart illustrating a process of setting a transmission amplifier gain value as used by the third preferred embodiment of the base station according to the current invention.

FIG. 7 is a diagram illustrating an exemplary wireless access systems with a base station and subscriber stations.

FIG. 8 is a diagram illustrating an exemplary separation unit for the base station and the subscriber station.

### DETAILED DESCRIPTION OF PREFERRED EMBODIMENTS

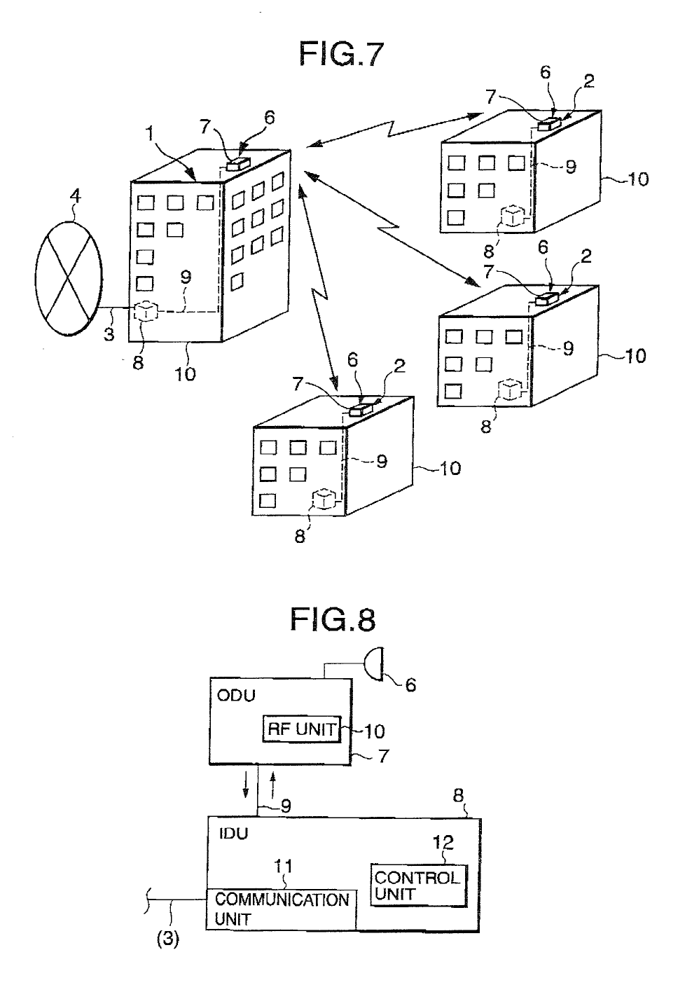

One preferred embodiment of the wireless communication system according to the current invention generally includes a first unit or the ODU having the wireless function primarily via antenna and a second unit or the IDU having the wireless function with the backbone communication network as shown in FIGS. 7 and 8. The preferred embodiment is applicable to both the base station 1 as well as to the subscriber station 2, and the difference is that the subscriber station 2 is connected to the back bone communication networks.

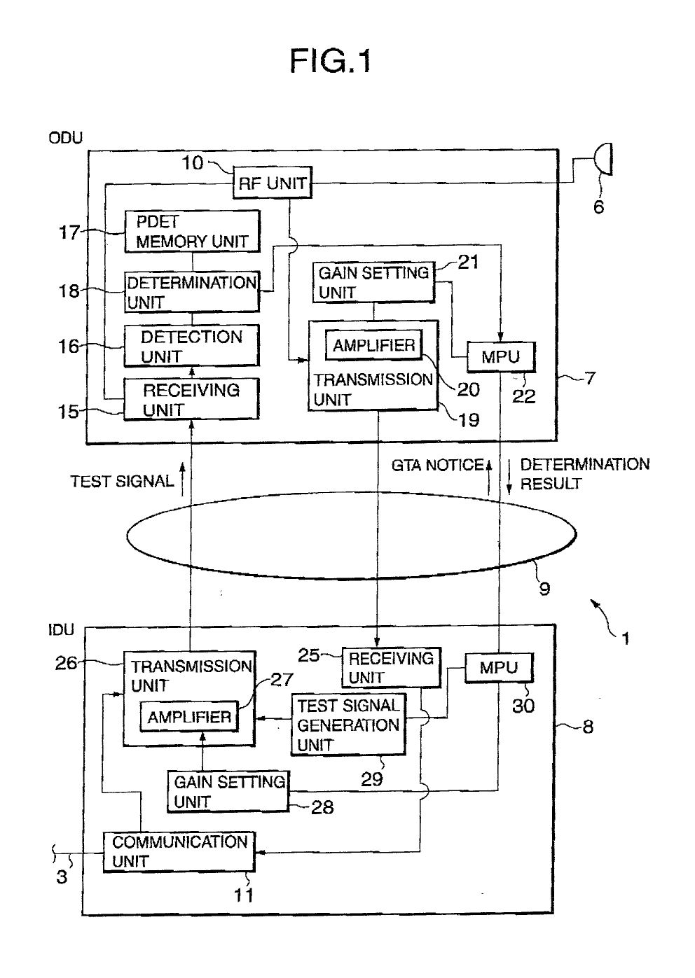

Referring to FIG. 1, a first preferred embodiment of the base station in the wireless communication system according to the current invention includes the ODU 7, the IDU 8 and the cable 9 connecting the ODU 7 to the IDU 8. The ODU 7 and the IDU 8 communicate transmission data such as voice information, image information and text information as well as control data such as notices and commands between the ODU 7 and the IDU 8. The ODU 7 further includes a reception unit 15 for receiving and processing a signal transmitted from the IDU 8 via the cable 9, a sensitivity detection unit 16 for detecting the reception sensitivity level at the reception unit 15, a PDET memory unit 17 for storing a predetermined standard reception sensitivity value for the ODU 7, a determination unit 18 for comparing and determining whether or not the reception sensitivity value that is detected by the sensitivity detection unit 16 matches the standard reception sensitivity value stored in the PDET memory unit 17, a transmission unit 19 for transmitting signals from the RF unit 10 to the IDU 8 via the communication cable 9, a transmission amplifier 20 for amplifying signals to be transmitted by the transmission unit 19, a gain setting unit 21 for setting a gain value of the transmission amplifier 20, and a control unit or MPU 22 for controlling the units of the IDU 8 and communicating with another control unit or MPU 30 on control information such as notices via the communication cable 9. The RU unit 10 wirelessly transmits via the antenna 6 signals that are received at the receiving unit 15 and whose test signal has been removed.

Still referring to FIG. 1, other than a communication unit 11 that processes the communication with the public communication network via a cable 3, the IDU 8 includes a receiving unit 25 for processing the transmitted signal from the ODU 7 via the communication cable 9, a transmission or transmitting unit 26 for transmitting a signal to the ODU 7 from the public communication network via the communication cable 9, a transmission amplifier 27, a test signal generating unit 29 for generating a test signal to be transmitted from the transmitting unit 26 upon the gain setting, and a control unit or MPU 30 for controlling the units of the IDU 8 as well as communicating with another control unit or MPU 22 on the ODU 7 side via the communication cable 9 on control information and notices. The communication unit 11 transmits the signal received and processed by the receiving unit 25 after the test signal has been removed.

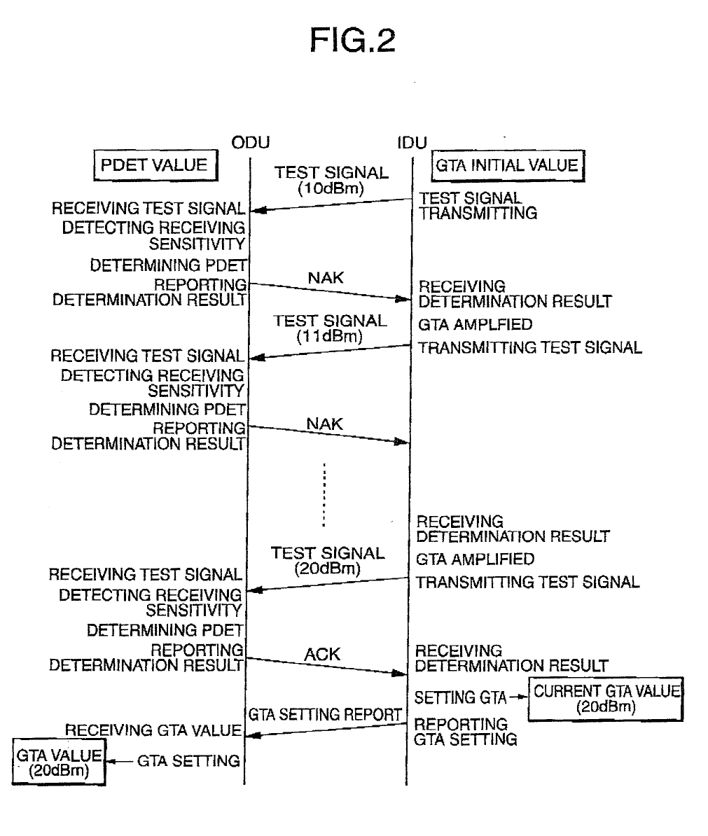

Now referring to FIG. 2, a timing chart illustrates a process of setting a transmission amplifier gain value as used by the preferred embodiment of the base station 1 according to the current invention. Although the illustrated process initiates the gain setting process upon installing the base station unit 1, the gain setting process is performed under the control by the control unit 22 or 30 on a periodic or non-periodic basis. Initially, the gain setting unit 28 of the IDU 8 stores an initialized value such as 10 dBm for gain (GTA) in the transmission amplifier 27 upon delivering from a factory. The amplifier 27 amplifies the test signal that has been generated by the signal generation unit 29 according to the above initialized gain value. The transmitting unit 26 transmits the amplified signal to the ODU 7 via the communication cable 9. In the ODU 7, the receiving unit 15 receives the test signal. The detection unit 16 detects the reception sensitivity level (PDET). The determination unit 18 compares the detected PDET to the standard reception sensitivity level that is stored in the PDET storing unit 17 and determines whether or not the reception sensitivity level of the test signal satisfies the standard reception sensitivity level. Based upon the above comparison or determination result, the control unit 22 via the communication cable 9 transmits a comparison signal such as a positive signal or ACK to the control unit 30 on the IDU side when the comparison result indicates the satisfaction of the standard reception sensitivity level.

On the other hand, as indicated in FIG. 2, the control level 22 via the communication cable 9 transmits a negative signal or NAK to the control unit 30 on the IDU side when the comparison result fails to indicate the standard reception sensitivity level. Upon receiving the NAK or the determination result in the IDU 8, the gain setting unit 28 increments the GTA by 1 dBm, and the transmitting amplifier 27 amplifies the test signal from the signal generation unit 29 based upon the increased gain. The transmitting unit 26 transmits the amplified test signal at 11 dBm to the ODU 7 via the communication cable 9. The ODU 7 subsequently performs the above described similar process upon receiving the test signal. Until the determination unit 18 obtains the positive result or ACK, the IDU 8 repeatedly and gradually increases the gain for the transmission amplifier 28 and transmits the test signal at 20 dBm. When the IDU 8 receives the positive ACK, the gain setting unit 28 has set 20 dBm for the corresponding transmission amplifier 27, and the control unit 30 transmits a GTA setting report signal that includes the above gain value to the control unit 22 of the ODU 7. In response to the report signal, the control unit 22 of the ODU 7 sets the new gain the value of the 20 dBm at the corresponding transmission amplifier 20. That is, the gain value of the transmission amplifier 27 on the IDU side for amplifying the signal from the IDU 8 to the ODU 7 is automatically reset so that the initial reception sensitivity level is obtained at the reception device. Similarly, the gain value of the transmission amplifier 20 on the ODU side for amplifying the signed from the ODU 7 to the IDU 8 is also automatically reset so that the initial reception sensitivity level is obtained at the reception device.

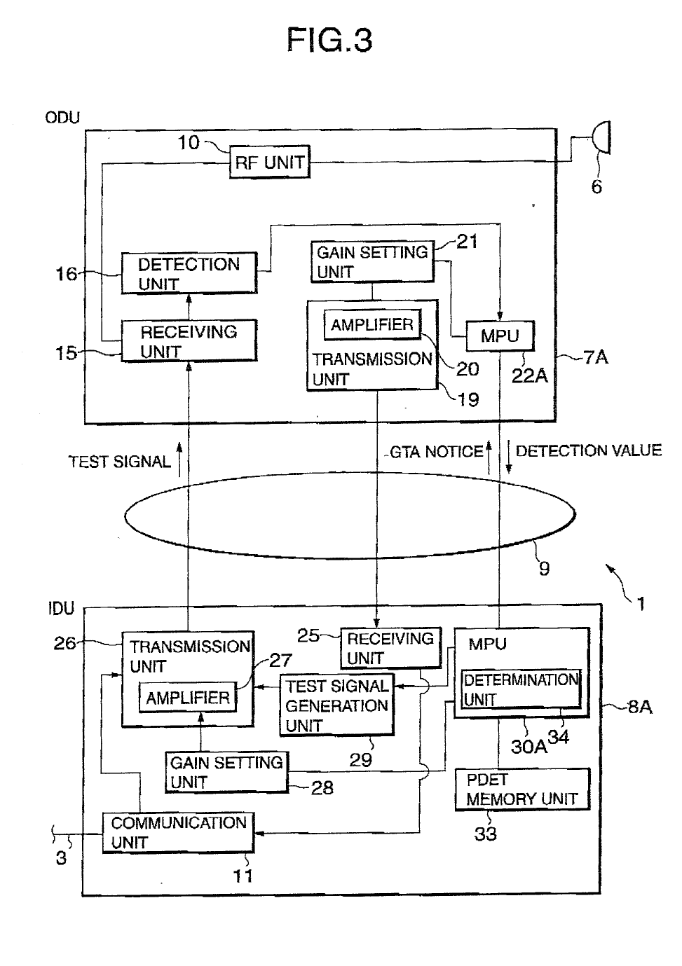

Now referring to FIG. 3, a diagram illustrates a second preferred embodiment of the base station 1 in the wireless communication system according to the current invention. In the second preferred embodiment, the ODU 7A and the IDU 8A are connected via the coaxial cable 9 as in the first preferred embodiment. The components of the second preferred embodiment that are substantially identical to those of the first preferred embodiment will not be described and are referenced by the same reference numerals. In comparison to the first preferred embodiment, the second preferred embodiment of the base station 1 has simplified functions for setting a gain value in the ODU side. The ODU 7A is compact and light weight in the second preferred embodiment by transferring the storing function and the determination function of the standard reception sensitivity level to the IDU 8A. That is, the detection unit 16 detects the reception sensitivity level of the test signal that is received by the reception unit 15 in the ODU 7A. The control unit 22A transmits the detected signal level to the control unit 30A of the IDU 8A without making any determination. On the other hand, the IDU 8A includes a PDET storing unit 33 for storing a predetermined standard reception sensitivity level value and a comparison unit 34 for determining whether or not the detected reception sensitivity value from the ODU 7A matches the standard reception sensitivity level as stored in the PDET storing unit 33 identically or within a predetermined range.

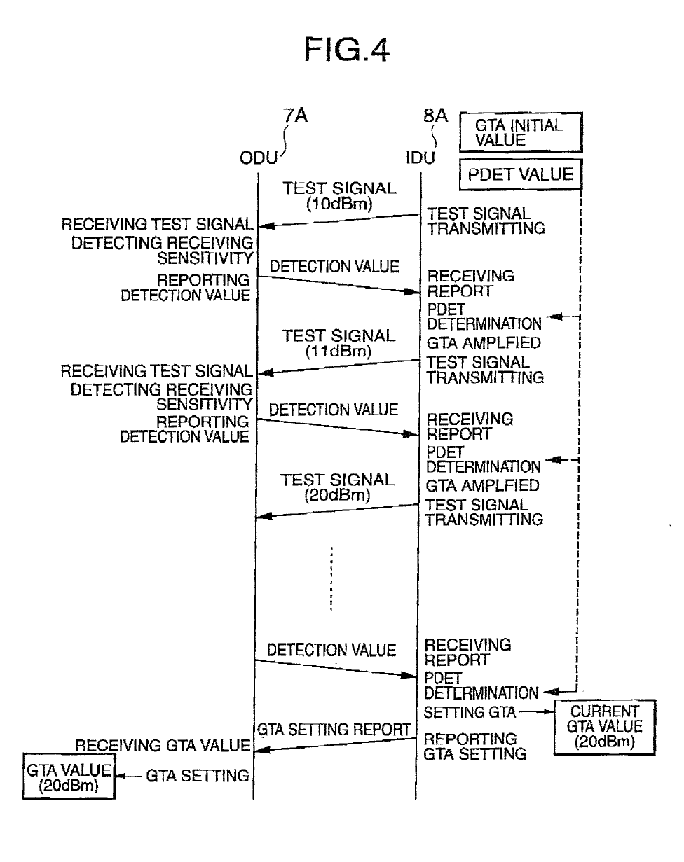

Now referring to FIG. 4, a timing chart illustrates a process of setting a transmission amplifier gain value as used by the second preferred embodiment of the base station 1 according to the current invention. Although the gain setting process is performed as an initial setting procedure upon installing the base station 1, the gain setting process is alternatively performed on a predetermined periodic basis or an irregular basis by the control unit 22A or 30A. Initially, the transmission amplifier 27 amplifies the test signal from the signal generation unit 29 according to a predetermined initial gain value of 10 dBm that is stored in the gain setting unit 27 of the IDU 8A. The transmission unit 26 transmits the amplified signal to the ODU 7A via the communication cable 9. The reception unit 15 in the ODU 7A receives the test signal, and the detection unit 16 detects the reception sensitivity or PDET. The control unit 22A sends the detected reception sensitivity level to the control unit 30A of the IDU 8A via the communication cable 9. Upon receiving the detected reception sensitivity value at the IDU 8A, the determination unit 34 compares the standard reception sensitivity level stored in the PDET storing unit 33 with the detected test signal sensitivity level on the ODU side and determines whether or not the test signal reception sensitivity level satisfies the standard reception sensitivity level. When a negative result is obtained, the gain setting unit 28 slightly increases the gain by 1 dBm, the transmission amplifier 27 amplifies the test signal from the signal generation unit 29 according to the increased gain value at 11 dBm. The transmission unit 26 sends the amplified signal to the ODU 7A via the communication cable 9. The ODU 7A performs the detection and reporting process based upon the above similar test signal. Until the determination unit 34 obtains a positive result, the IDU 8 gradually increases the gain to 20 dBm for the transmission amplifier 28 and transmits the test signal.

When the determination result at the IDU 8A becomes positive, the gain setting unit 28 has set the corresponding amplifier 27 at 20 dBm. The control unit 30A sends a setting report including the current gain value to the control unit 22A of the ODU 7A. In response to the above report, the control unit 22A sets the reported gain value for 20 dBm at the corresponding transmission amplifier 20. In other words, the gain value of the amplifiers 27 and 20 for the signal going to and from the ODU 7A is automatically set so that the initial reception sensitivity level is obtained at the reception device.

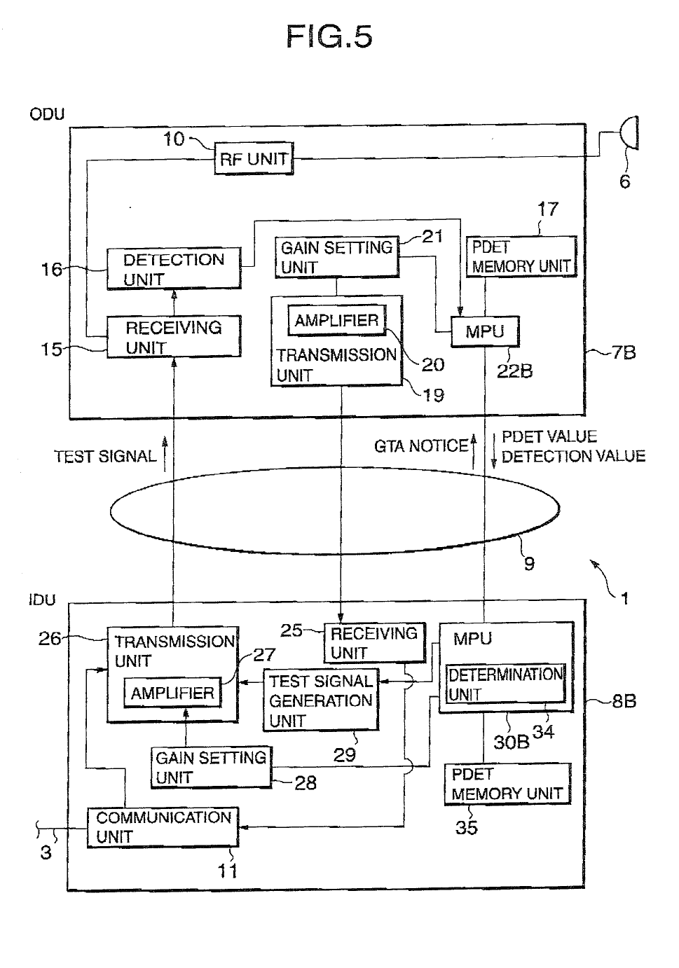

Now referring to FIG. 5, a diagram illustrates a third preferred embodiment of the base station 1 in the wireless communication system according to the current invention. In the third preferred embodiment, the ODU 7B and the IDU 8B are connected by the coaxial cable 9 as in the first and second preferred embodiments, the components that are substantially identical to those in the first or second preferred embodiment will not be described and are referred by the same reference numerals. The third preferred embodiment of the base station 1 is simplified by transferring the determination function of the reception sensitivity to the IDU 8B as in the second preferred embodiment. However, the storing function for the standard reception sensitivity level is in the ODU 7B. The standard reception sensitivity level as uniquely set for the ODU 7B is used for the sensitivity determination. In other words, the PDET storing unit 17 of the ODU 7B stores a predetermined standard reception sensitivity level. Prior to setting the gain, the control unit 22B sends the standard reception sensitivity level value to the control unit 30B in the IDU 8B via the communication cable 9. During the gain setting process, the detection unit 16 detects the reception sensitivity level of the test signal that is received by the reception unit 15. The control unit 22B sends the reception sensitivity level to the control unit 30B without evaluating it. On the other hand, the IDU 8B includes a PDET storing unit 35 the standard reception sensitivity level value for the ODU 7B at least until the gain setting is finished. The determination unit 34 compares and determines whether or not the detected reception sensitivity level from the ODU 7B matches or is within a predetermined range of the standard reception sensitivity value that is stored in the PDET memory unit 35.

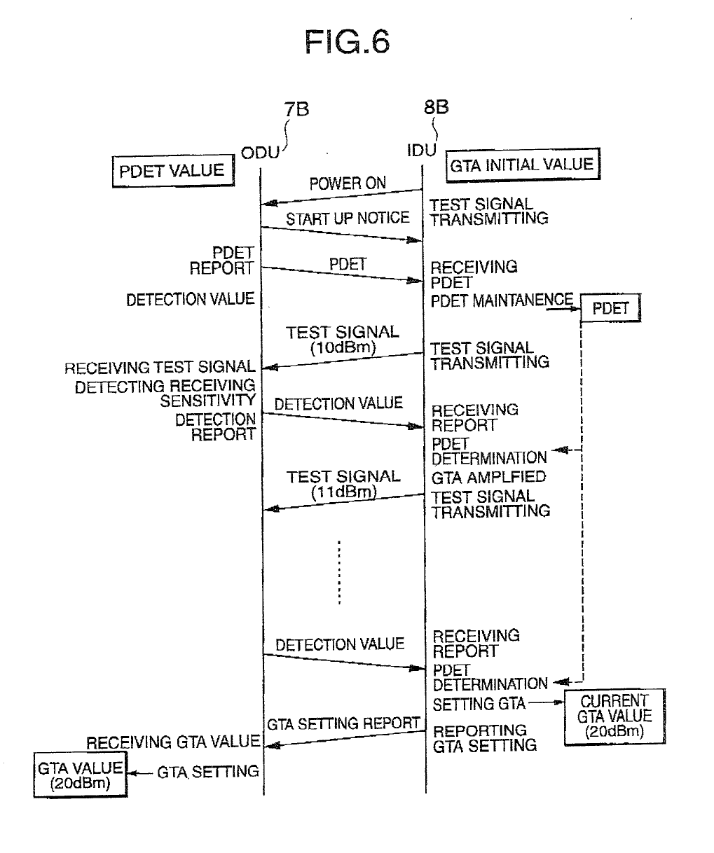

Now referring to FIG. 6, a timing chart illustrates a process of setting a transmission amplification gain value as used by the third preferred embodiment of the base station 1 according to the current invention. Although the gain setting process is performed as an initial setting procedure upon installing the base station 1, the gain setting process is alternatively performed on a predetermined periodic basis or an irregular basis by the control unit 22B or 30B. Prior to setting the gain after turning on the IDU 8B, the ODU 7B reports the standard reception sensitivity level value as stored unit 35 in the IDU 8B stores the above standard reception sensitivity level value. The subsequent gain setting process is similarly performed as the second preferred process. The IDU 8B transmits the test signal that has bee amplified by the transmission amplifier 27 based upon the initial gain value to the ODU 7B via the communication cable 9. The detection unit 16 in the ODU 7B detects the reception sensitivity level of the test signal the control unit 22B sends to the control unit 30B in the IDU 8B. The above detected reception sensitivity level value via the communication cable 9. In the IDU 8B, the determination unit 34 compares the above detected reception sensitivity level value as store in the PDET storing unit 35 to determine whether or not the reception sensitivity level of the test signal satisfies the standard reception sensitivity level. If the above comparison is negative, the IDU 8B increases the gain for the transmission amplifier 28 in a repeated manner until the above comparison result becomes positive. When the comparison result becomes positive, the gain setting unit 28 sets the corresponding gain value at the transmission amplifier 27. The control unit 30B sends to the control unit 22B in the ODU 7B a report including the above gain value. The gain setting unit 21 of the ODU 7B sets the reported gain value at the corresponding transmission amplifier 20.

In the above preferred embodiment, the detected reception sensitivity level is lower than the standard reception sensitivity level. However, when the detected reception sensitivity level is higher than the standard reception sensitivity level, the gain of the transmission amplifier 28 is gradually decreased until the standard reception sensitivity level is satisfied. The corresponding gain value is used to set the transmission amplifier 20 or 27.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of adjusting amplification gain for a communication signal, comprising the steps of:
storing a predetermined standard reception sensitivity value;
amplifying the communication signal at an amplification level at a first unit;
transmitting the amplified communication signal from the first unit to a second unit;
receiving the communication signal at the second unit;
comparing the received communication signal to the predetermined standard reception sensitivity value to generate a comparison signal;
adjusting the amplification level at the first unit based upon the comparison signal until a desirable amplification is reached;
transmitting the amplification level from the first unit to the second unit upon achieving the desirable amplification; and
storing the amplification level at the second unit for amplification gain at the second unit.

2. The method of adjusting amplification gain for a communication signal according claim 1 further comprising a steps of:
amplifying the communication signal at the stored amplification level at the second unit; and
transmitting the amplified communication signal from the second unit to the first unit.

3. The method of adjusting amplification gain for a communication signal according claim 1 wherein the predetermined standard reception sensitivity value is stored in the first unit.

4. The method of adjusting amplification gain for a communication signal according claim 1 wherein the predetermined standard reception sensitivity value is stored in the second unit.

5. The method of adjusting amplification gain for a communication signal according claim 1 wherein said comparing takes place in the second unit.

6. The method of adjusting amplification gain for a communication signal according claim 1 wherein said comparing takes place in the first unit.

7. The method of adjusting amplification gain for a communication signal according claim 6 further comprising an additional step of transmitting the received communication signal from the second unit to the first unit prior to said comparing.

8. The method of adjusting amplification gain for a communication signal according claim 6 wherein the predetermined standard reception sensitivity value is stored in the second unit and further comprising additional steps of:
transmitting the stored predetermined standard reception sensitivity value from the second unit to the first unit; and
transmitting the received communication signal from the second unit to the first unit prior to said comparing.

9. The method of adjusting amplification gain for a communication signal according claim 1 wherein said adjusting increments the amplification level by a predetermined unit.

10. A system for adjusting amplification gain for a communication signal, comprising:
a first unit including a first amplifier for amplifying the communication signal at an amplification level, a first transmitter connected to the amplifier for transmitting the amplified communication signal and a first memory for storing an amplification level; and
a second unit connected to said first unit including a receiver for receiving the communication signal, a second memory for storing a predetermined standard reception sensitivity value and a comparator for comparing the received communication signal to the predetermined standard reception sensitivity value to generate a comparison signal, wherein said first unit adjusts the amplification level of the first amplifier to a desirable amplification level based upon the comparison signal until a desirable amplification is reached at said second unit, said first unit storing the amplification level in the first memory, said first unit transmitting the desirable amplification level to said second unit upon achieving the desirable amplification, the second unit storing the desirable amplification level.

11. The system for adjusting amplification gain for a communication signal according claim 10 wherein said second unit further comprises a second amplifier for amplifying the communication signal at the stored desirable amplification level and a second transmitter connected the second amplifier for transmitting the amplified communication signal from said second unit to said first unit.

12. The system for adjusting amplification gain for a communication signal according claim 10 wherein said first unit increments the amplification level by a predetermined unit.

13. The system for adjusting amplification gain for a communication signal according claim 10 further comprising a cable for connecting said first unit and said second unit to transmit the amplified communication signal.

14. The system for adjusting amplification gain for a communication signal according claim 10 further comprising an antenna connected to said second unit and a network connected to said first unit.

15. A system for adjusting amplification gain for a communication signal, comprising:
a first unit including a first amplifier for amplifying the communication signal at an amplification level, a first transmitter connected to the amplifier for transmitting the amplified communication signal, a first memory for storing a predetermined standard reception sensitivity value and a comparator for comparing two signals; and
a second unit connected to said first unit including a receiver for receiving the communication signal, said second unit transmitting the received communication signal back to said first unit, wherein the comparator compares the received communication signal from said second unit to the predetermined standard reception sensitivity value to generate a comparison signal, said first unit adjusting the amplification level of the first amplifier to a desirable amplification level based upon the comparison signal until a desirable amplification is reached at said second unit, said first unit transmitting the desirable amplification level to said second unit upon achieving the desirable amplification, said second unit storing the desirable amplification level.

16. The system for adjusting amplification gain for a communication signal according claim 15 wherein said second unit further comprises a second amplifier for amplifying the communication signal at the stored desirable amplification level and a second transmitter connected the second amplifier for transmitting the amplified communication signal from said second unit to said first unit.

17. The system for adjusting amplification gain for a communication signal according claim 15 wherein said first unit increments the amplification level by a predetermined unit.

18. The system for adjusting amplification gain for a communication signal according claim 15 further comprising a cable for connecting said first unit and said second unit to transmit the amplified communication signal.

19. The system for adjusting amplification gain for a communication signal according claim 15 further comprising an antenna connected to said second unit and a network connected to said first unit.

20. A system for adjusting amplification gain for a communication signal, comprising:
a first unit including a first amplifier for amplifying the communication signal at an amplification level, a first transmitter connected to the amplifier for transmitting the amplified communication signal, a first memory for storing an amplification value and a comparator for comparing two signals; and
a second unit connected to said first unit including a receiver for receiving the communication signal and a second memory for storing a predetermined standard reception sensitivity value, said second unit sending the predetermined standard reception sensitivity value to the first memory in said first unit, said second unit transmitting the received communication signal back to said first unit, wherein the comparator compares the received communication signal from said second unit to the predetermined standard reception sensitivity value to generate a comparison signal, said first unit adjusting the amplification level of the first amplifier to a desirable amplification level based upon the comparison signal until a desirable amplification is reached at said second unit, said first unit transmitting the desirable amplification level to said second unit upon achieving the desirable amplification, said second unit storing the desirable amplification level.

21. The system for adjusting amplification gain for a communication signal according claim 20 wherein said second unit further comprises a second amplifier for amplifying the communication signal at the stored desirable amplification level and a second transmitter connected the second amplifier for transmitting the amplified communication signal from said second unit to said first unit.

22. The system for adjusting amplification gain for a communication signal according claim 20 wherein said first unit increments the amplification level by a predetermined unit.

23. The system for adjusting amplification gain for a communication signal according claim 20 further comprising a cable for connecting said first unit and said second unit to transmit the amplified communication signal.

24. The system for adjusting amplification gain for a communication signal according claim 20 further comprising an antenna connected to said second unit and a network connected to said first unit.
